(19) United States
(12) Patent Application Publication
(10) Pub. No.: US 2021/0172545 A1
(43) Pub. Date: Jun. 10, 2021

(54) PNEUMATIC HOSE FASTENER

(71) Applicants: James Paterson KENNEDY, III, San Clemente, CA (US); Patricia Elaine KENNEDY, San Clemente, CA (US)

(72) Inventors: James Paterson KENNEDY, III, San Clemente, CA (US); Patricia Elaine KENNEDY, San Clemente, CA (US)

(21) Appl. No.: 17/024,623

(22) Filed: Sep. 17, 2020

Related U.S. Application Data
(60) Provisional application No. 62/901,451, filed on Sep. 17, 2019.

(51) Int. Cl. F16L 3/12; F16L 3/00; F16L 3/18

(52) U.S. Cl. CPC F16L 3/1222; F16L 3/18; F16L 3/003

(57) ABSTRACT

A pneumatic hose fastener having a flange with a pair of overlapping non-concentric holes attached by a neck to a hook. The overlapping non-concentric holes are adapted to receive a pneumatic hose and quick-connect coupler body. The hook includes an inner hook leg attached to an outer hook leg by a bridge. The bridge connects to the neck. A side profile of the inner hook leg, the bridge and the outer hook leg form substantially a u-shape adapted to secure the hook of the pneumatic hose fastener to another surface.

### CROSS REFERENCE TO RELATED APPLICATION

This application is a Non-Provisional application and claims priority to U.S. Provisional Application Ser. No. 62/901,451 filed Sep. 17, 2019, the contents of all of which are hereby incorporated by reference herein in their entirety into this disclosure.

### TECHNICAL FIELD

### 1. Technical Field

The subject disclosure relates generally to a pneumatic hose fastener adapted for universal use with pneumatic equipment having a hose attachment aperture, an inner securement tail and an outer substantially u-shaped attachment hook.

### 2. Description of the Related Art

Conventionally, a solution for carrying and/or dragging a pneumatic hose by a construction worker did not exist. The worker traditionally had to maneuver carrying all of their equipment in addition to a pneumatic hose. This task can be quite difficult, for example, when climbing up a ladder where two hands are required to climb a ladder making it quite difficult to manipulate a hose along with the equipment needed by the worker at a remote location.

### SUMMARY

A pneumatic hose fastener having a flange with a pair of overlapping non-concentric holes attached by a neck to a hook. The overlapping non-concentric holes being adapted to receive a pneumatic hose and quick-connect coupler body. The hook includes an inner hook leg attached to an outer hook leg by a bridge. The bridge connects to the neck. A side profile of the inner hook leg, the bridge and the outer hook leg form substantially a u-shape adapted to secure the hook of the pneumatic hose fastener to another surface.

### BRIEF DESCRIPTION OF THE DRAWINGS

Various exemplary embodiments of this disclosure will be described in detail, wherein like reference numerals refer to identical or similar components or steps, with reference to the following figures, wherein:

FIG. 1 illustrates a right-side view of the pneumatic hose fastener.

FIG. 2 illustrates a left side view of the pneumatic hose fastener.

FIG. 3 illustrates a top perspective of the pneumatic hose fastener laying on its left side.

FIG. 4 illustrates a rear view of the pneumatic hose fastener laying on its left side.

FIG. 5 illustrates a front perspective of the pneumatic hose fastener.

FIG. 6 illustrates a bottom perspective of the pneumatic hose fastener.

FIG. 7 illustrates a front perspective of the pneumatic hose fastener focusing on the inner hook leg.

FIG. 8 shows a right-side view of the pneumatic hose fastener attached to a hose connected to a quick-connect coupler body.

FIG. 9 shows a top perspective of the pneumatic hose fastener attached to a hose connected to a quick-connect coupler body.

FIG. 10 shows a bottom perspective of the pneumatic hose fastener attached to a hose connected to a quick-connect coupler body.

FIG. 11 a front perspective of the pneumatic hose fastener attached to a hose connected to a quick-connect coupler body further attached to the hose body in a storage position.

### DETAILED DESCRIPTION

Particular embodiments of the subject disclosure will now be described in greater detail with reference to the figures.

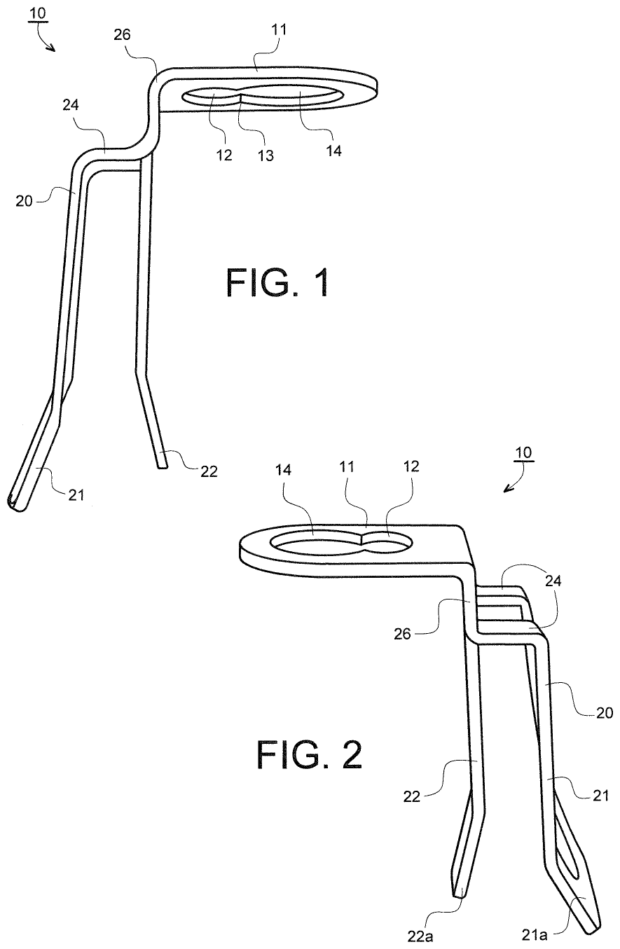

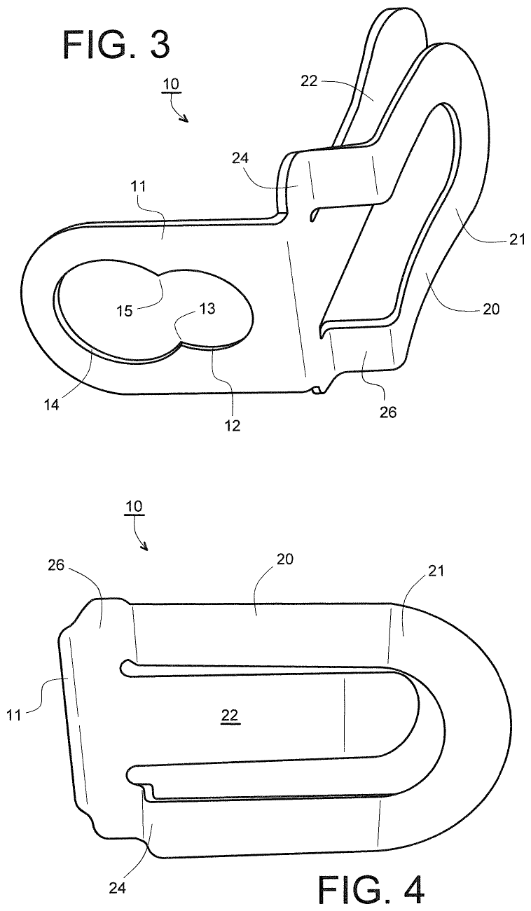

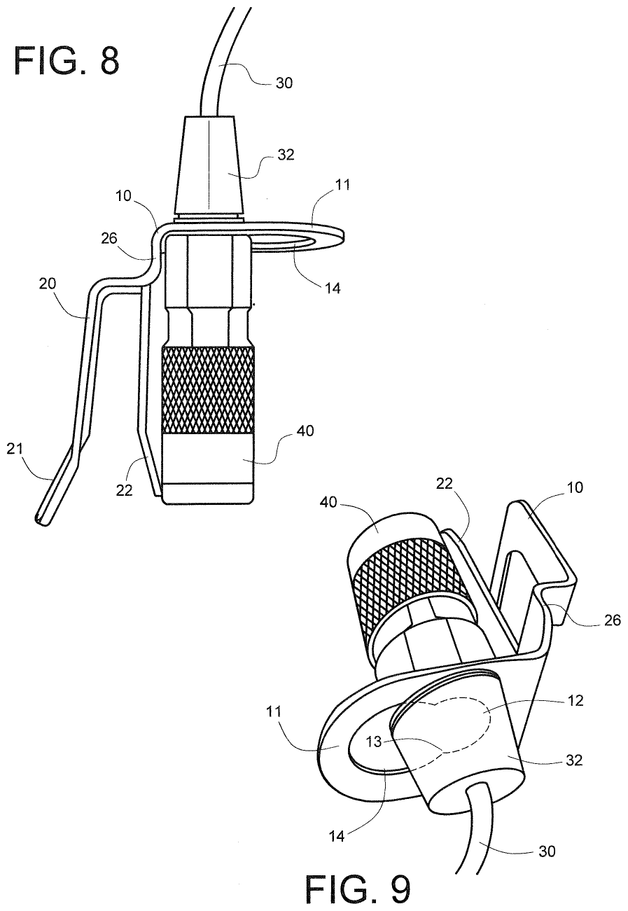

FIG. 1 illustrates a right-side view of the pneumatic hose fastener 10. The pneumatic hose fastener 10 has a top shelf or flange 11 having two overlapping non-concentric holes 12, 14 (as shown in FIGS. 3 and 6) for the attachment of a pneumatic hose 30 and a quick-connect coupler body 40 (as shown in FIG. 8). The pneumatic hose fastener 10 has an attachment hook 20 attached to the flange 11 by a neck 26.

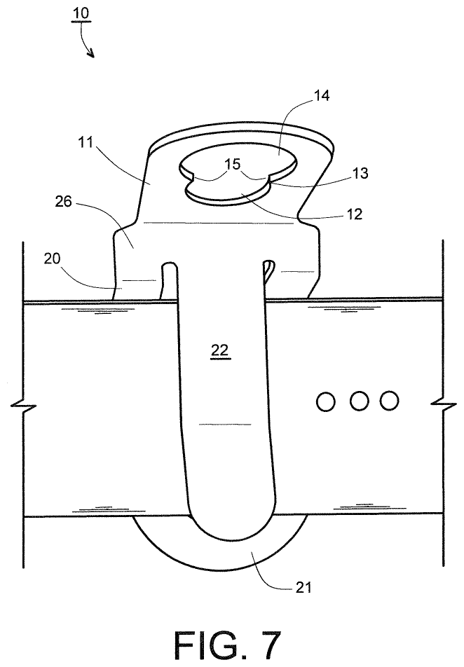

The attachment hook 20 is substantially u-shaped and is composed of an outer hook leg 21 connected by a horizontal bridge 24 to an inner hook leg 22. The horizontal bridge 24 of the attachment hook 20 is connected to the flange 11 by the neck 26. As shown in FIG. 7, the u-shaped construction of the attachment hook 20 is adapted to be friction fit snugly onto another object 5, such as a belt, a utility belt, a belt portion of a pair of trousers, or the like.

The pneumatic hose fastener 10 may be of a one-piece construction. However, it is to be understood that the pneumatic hose fastener 10 may be of a modular construction. The pneumatic hose fastener 10 in the embodiment shown may be made of approximately 16-gauge steel, however it is contemplated that the pneumatic hose fastener 10 could be formed from other material such as aluminum, copper, brass, various metal alloys, plastic, carbon fiber, textiles and/or similar strong rigid material. The gauge of the material used in the construction of the pneumatic hose fastener 10 could be larger or smaller as well.

FIG. 2 illustrates a left side view of the pneumatic hose fastener 10 next to a ruler for one perspective. However, it is to be understood that the pneumatic hose fastener 10 may take variety of sizes and shapes according to this disclosed subject matter. Shown is the left side view of the pneumatic hose fastener 10 illustrating the outer hook leg 21 of the attachment hook 20, which is disposed on the outer perimeter of the pneumatic hose fastener 10, and together with the inner hook leg 22 are constructed in a substantially u-shaped configuration. As shown, the outer hook leg 21 is provided as a single u-shape leg, each end of the outer hook leg 21 having corresponding horizontal bridges 24 adapted to attach the outer hook leg 21 to the inner hook leg 22 through the neck 26. It is to be understood that the outer hook leg 21 may be constructed in a variety of different configurations including a pair of disconnected outer hook legs 21 joined at the horizontal bridge 24.

As shown, the attachment hook 20 is constructed with a predetermined length adapted to provide a friction fit with the belt 5 that would make removal of the pneumatic hose fastener 10 difficult without manual removal. A lower outer end 21a of the outer hook leg 21 has a slight outward flair. And, a lower inner end 22a of the inner hook leg 22 has a slight inward flair. The flaired portions of the lower outer end 21a and lower inner end 22a are provided to allow a user to easily attach the attachment hook 20 portion of the pneumatic hose fastener 10 to another object, such as the belt 5 or other item.

FIG. 2 illustrates the spatial arrangement of the attachment hook 20 relative to the flange 11. That is, the inner hook leg 22, and the horizontal bridge 24 that extends into the inner hook leg 22. The u-shape attachment hook 20 is attached to the flange 11 through the neck 26.

Although the width of the pneumatic hose fastener 10 is shown as approximately 2 inches from a first end to a second end, it is contemplated that the pneumatic hose fastener 10 could be made larger or smaller and/or wider or thinner to accommodate larger or smaller pneumatic hoses 30 and/or quick-connect coupler bodies 40, or to better fit with larger or smaller points of attachments. The size of the non-concentric holes 12, 14 could be kept static with a larger or smaller construction or could adopt different sized configurations as well.

FIG. 3 illustrates a top perspective of the pneumatic hose fastener 10 that shows the non-concentric holes 12, 14 designed to accommodate two different sized pneumatic hoses 30 and quick-connect coupler body 40 configurations. The National Pipe Thread (NPT) standard recommends two different industry standard sized hoses, both ¼″ and ⅜″ sized hoses. The pneumatic hose fastener 10 has two non-concentric holes 12,14 designed to fit these two standard NPT sizes. The non-concentric holes 12, 14 are not fully concentric and overlapping in order to facilitate the installation of the pneumatic hose 30 and a mating attachment of the quick-connect coupler body 40.

FIG. 3 illustrates the construction of the flange 11 in more detail. A waist 13 portion is disposed between the larger non-concentric hole 14 and the smaller non-concentric hole 12. The waist 13 acts as a retainer or safety device to lock the quick-connect coupler body 40 in place on the flange 11 of the pneumatic hose fastener 10 as shown in FIG. 8. Likewise, the waist 13 acts as a sliding stop retainer to prevent the pneumatic hose 30 attached to the quick-connect coupler body 40 from sliding from the smaller non-concentric hole 12 (such as a ¼ inch) into the larger non-concentric hole 14 (such as a ⅜ inch) and becoming loosened and/or disconnected. The waist 13 has a pinched point between the larger non-concentric hole 14 and the smaller non-concentric hole 12. The pinch point is smaller than the outer diameter of the smaller non-concentric hole 12 so that the pneumatic hose 30 that is snugly placed within the smaller non-concentric hole 12 does not slip out of position. Likewise, when a larger pneumatic hose 30 is placed within the larger non-concentric hole 14, the larger pneumatic hose 30 would not slip out of its position. As described in more detail later, to install the pneumatic hose 30 into the pneumatic hose fastener 10, the quick-connect coupler body 40 would be disconnected from a mating fitting 32 on the end of the pneumatic hose 30. The end of the mating fitting 32 would be inserted into one of the non-concentric holes 12, 14 and the end of the quick-connect coupler body 40 would be reconnected to the end of the mating fitting 32 that has been located within one of the non-concentric holes 12, 14 as shown in FIG. 8.

Likewise, the inner hook leg 22 and the outer hook leg 21 of the attachment hook 20 is also another safety feature designed to provide a friction fit clamp on to another item such as the belt 5 in order to protect the pneumatic hose 30 and the quick-connect coupler body 40 from accidentally disengaging from the pneumatic hose fastener 10 attached to a user. The position and configuration of the inner hook leg 22 and the outer hook leg 21 of the attachment hook 20 prevents the quick-connect coupler body 40 from pulling back and releasing from the pneumatic hose fastener 10.

The size, configuration and number of the non-concentric holes 12, 14 may be different in order to accommodate different sized hoses or coupler bodies. For example, the size of the larger non-concentric hole 14 and the smaller non-concentric hole 12 could be adapted for use with standards of various countries that require particular standards, such as the U.S. customary system, the metric system and/or any other suitable standard for measurement.

FIG. 4 illustrates a rear view of the pneumatic hose fastener 10 that shows the outer hook leg 21 and the inner hook leg 22 of the attachment hook 20. In the embodiment shown, the outer hook leg 21 of the attachment hook 20 is substantially u-shaped having an open body configuration. The top of the outer hook leg 21 is connected by the horizontal bridge 24 to the inner hook leg 22 and the flange 11 of the pneumatic hose fastener 10. As shown, the bottom portions of the outer hook leg 21 and the inner hook leg 22 of the attachment hook 20 flair slightly away from each other to facilitate an easy attachment and help to align the pneumatic hose fastener 10 when the user plans to hang their equipment to their belt 5. It is contemplated that the outer hook leg 21 and the inner hook leg 22 of the attachment hook 20 could adopt a variety of shapes and sizes. For example, the outer hook leg 21 could have an open bottom portion, or an enclosed middle portion. Similarly, the inner hook leg 22 could be substantially u-shaped, triangular, elliptical, circular, and/or any other applicable shape.

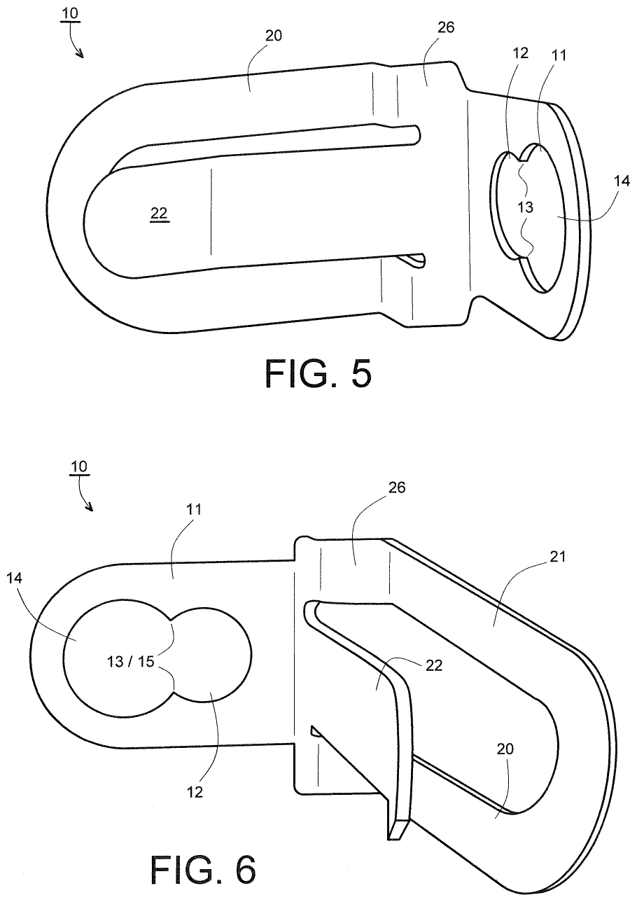

FIG. 5 shows a front view of the pneumatic hose fastener 10. The pneumatic hose fastener 10 may take a variety of different dimensions and/or constructions. In one embodiment, the pneumatic hose fastener 10 may be approximately 2.25″ in height from the top to the bottom. However, the height of the pneumatic hose fastener 10 could be larger or smaller depending on the configuration. As shown, the inner hook leg 22 is disposed in front of the outer hook leg 21 of the attachment hook 20 and flairs away from the outer hook leg 21. The lower end of the outer hook leg 21 may be constructed to slightly flair away from the inner hook leg 22 in the opposite direction. However, the outer hook leg 21 and the inner hook leg 22 could be made with complementary curving portions in order to facilitate attachment and the holding of the pneumatic hose 30 and quick-connect coupler body 40.

FIG. 6 shows a bottom perspective of the pneumatic hose fastener 10. From this perspective the bottom of the two non-concentric holes 12, 14 of the flange 11 are shown. The smaller non-concentric hole 12 (such as for a ¼ inch hose) merges and slightly overlaps with the larger non-concentric hole 14 (such as for a ⅜ inch hose). These non-concentric holes 12, 14 are adapted for use with the two NPT standard sized hoses. Between the larger non-concentric hole 14 and smaller non-concentric hole 12 is the waist 13 that narrows the space between the non-concentric holes 12, 14. As mentioned previously, the waist 13 prevents the quick-connect coupler body 40 and the pneumatic hose 30 from being jostled from with the respective non-concentric holes 12, 14 and/or disconnected from the pneumatic hose fastener 10 during use.

FIG. 7 shows a front view of the pneumatic hose fastener 10. In the embodiment shown, the pneumatic hose fastener 10 may be constructed to be approximately 1.5 inches in width. However, the pneumatic hose fastener 10 could be wider or narrower depending on its intended use. FIG. 7 also illustrates the inner hook leg 22. The inner hook leg 22 is shown with a lower end in the shape of a U with an enclosed middle. The inner hook leg 22 is shown as a single piece of steel with parallel edges and a curved bottom portion that flairs towards the front of the pneumatic hose fastener 10. In the attachment hook 20. there is a space between the outer hook leg 21 and the inner hook leg 22 used from attaching the pneumatic hose fastener 10 to the belt 5, such as a pocket, bag, belt, ladder, trousers or the like. In use, there is friction fit and compression tension between the inner hook leg 22 and the outer hook leg 21 that assists in keeping the pneumatic hose fastener 10 attached to the surface by way of the friction fit and the compression force within the attachment hook 20. It is contemplated that the inner hook leg 22 could snap behind the outer hook leg 21 in a locked position, or vice versa, in order to provide an even tighter attachment.

FIG. 8 shows a right-side view of the pneumatic hose fastener 10 attached to the quick-connect coupler body 40 and the mating fitting 32 attached to an end of the pneumatic hose 30. The mating fitting 32 is connected to the quick-connect coupler body 40 through the smaller non-concentric hole 12. The inner hook leg 22 is designed to secure and protect the pneumatic hose 30 and quick-connect coupler body 40 from accidentally disengaging. Accordingly, the inner hook leg 22 is shown as substantially the length of the quick-connect coupler body 40. The lower portions of the attachment hook 20 and the inner hook leg 22 flair in opposite directions in order to facilitate attachment of a friction fit attachment, and to assist in aligning the pneumatic hose fastener 10 when the user plans to hang their equipment.

FIG. 9 shows a top perspective of the pneumatic hose fastener 10 attached between the quick-connect coupler body 40 and the mating fitting 32. The tight fit between the mating fitting 32 of the pneumatic hose 30 and the smaller non-concentric hole 12 in the flange 11 is shown. A pinch point 15 in the waist 13 between the non-concentric holes 12, 14 prevents the pneumatic hose 30 from slipping into the larger non-concentric hole 14 of the two non-concentric holes 12, 14 and potentially causing slop and/or disengaging the pneumatic hose fastener 10 from the smaller hose 12. The flange 11 may also serves as a guard that slips into a slot disposed in a female recessed portion of the quick-connect coupler body 40. This engagement serves to prevent the pneumatic hose fastener 10 from sliding back and releasing the connection between the pneumatic hose 30 and the quick-connect coupler body 40.

FIG. 10 shows a bottom perspective of the pneumatic hose fastener 10. The hose 30 connects to the quick-connect coupler body 40 through the smaller non-concentric hole 12 of the two non-concentric holes 12, 14 in the flange 11 of the pneumatic hose fastener 10. This arrangement provides a secure connection between the pneumatic hose 30 and the quick-connect coupler body 40 through the pneumatic hose fastener 10 for further attachment to an attachment surface. FIG. 10 also shows the neck 26 that attaches the horizontal bridge 24 between the outer hook leg 21 and inner hook leg 22 of the attachment hook 20 to the flange 11. The neck 26 is sized for the inner hook leg 22 to be substantially the size of the quick-connect coupler body 40, however, the neck 26 could be larger or smaller to facilitate different sized coupler bodies or attachment configurations.

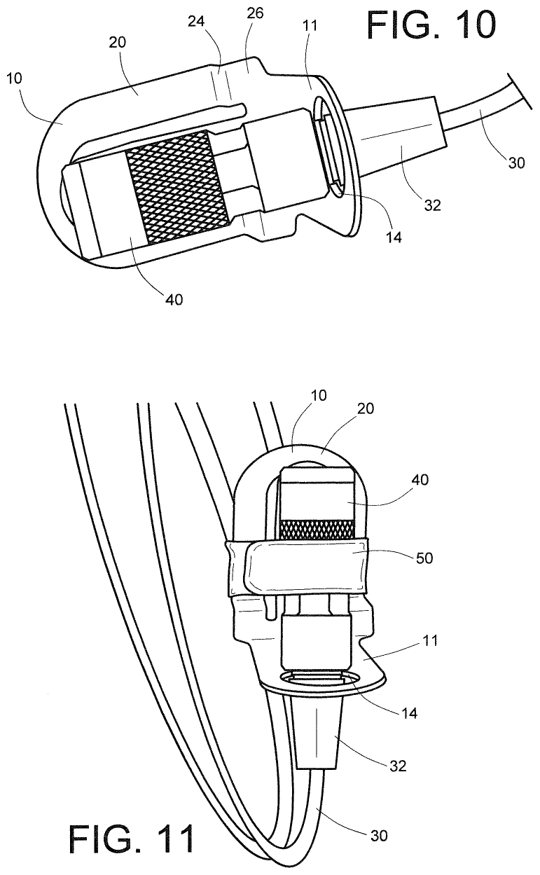

FIG. 11 shows the pneumatic hose fastener 10 attached between the mating fitting 32 of the pneumatic hose 30 and the quick-connect coupler body 40 in a storage position. The pneumatic hose fastener 10 is designed to remain attached to the pneumatic hose 30 and the quick-connect coupler body 40 when in a storage position. The attachment portions and non-concentric holes 12, 14 provide different storage options for the user.

FIG. 11 illustrates a hook and loop fastener 50 that can be used to connect the pneumatic hose fastener 10 to a coiled length of the pneumatic hose 30. In storage, the hook and loop fastener 50 can be used to easily attach the pneumatic hose fastener 10 to a pneumatic hose 30 during non-use and hung with the pneumatic hose 30. Alternative, the pneumatic hose fastener 10 could be used as a hanger in which the hose 30 and pneumatic hose fastener 10 can be hung from any surface of the pneumatic hose fastener 10, such as various attachment portions or from the non-concentric holes 12, 14.

The illustrations and examples provided herein are for explanatory purposes and are not intended to limit the scope of the appended claims. It will be recognized by those skilled in the art that changes, or modifications may be made to the above described embodiment without departing from the broad inventive concepts of the invention. It is understood therefore that the invention is not limited to the particular embodiment, which is described, but is intended to cover all modifications and changes within the scope and spirit of the invention.

What is claimed:

1. A pneumatic hose fastener comprising:
a flange having at least one hole to receive a pneumatic hose with a quick-connect coupler body; and
a hook attached to the flange, the hook comprising;
an inner leg; and
an outer leg,
wherein a side profile of the inner leg and the outer leg substantially form a u-shape adapted to secure the hook to another surface.

2. The pneumatic hose fastener recited in claim 1, wherein the at least one hole is two overlapping non-concentric holes.

3. The pneumatic hose fastener recited in claim 2, wherein a waist portion is disposed between the two overlapping non-concentric holes.

4. The pneumatic hose fastener recited in claim 3, wherein the waist portion has a pinch point between a larger hole and a smaller hole of the two overlapping non-concentric holes.

5. The pneumatic hose fastener recited in claim 4, wherein the pinch point is smaller than an outer diameter of the smaller hole so that the pneumatic hose snugly placed within the smaller hole does not slip out of position.

6. The pneumatic hose fastener recited in claim 1, wherein the hook is attached to the flange through a neck.

7. The pneumatic hose fastener recited in claim 6, wherein a bridge extends between the inner leg and the outer leg and connects to the neck.

8. The pneumatic hose fastener recited in claim 1, wherein a bridge is formed at an upper end of the outer leg.

9. The pneumatic hose fastener recited in claim 1, wherein the outer leg is constructed in a u-shape.

10. The pneumatic hose fastener recited in claim 1, wherein the inner leg is constructed in a tongue shape.

11. A pneumatic hose fastener comprising:
a flange having at least one hole to receive a pneumatic hose with a quick-connect coupler body; and
a hook attached to the flange through a neck, the hook comprising;
an inner leg; and
an outer leg,
wherein a side profile of the inner leg and the outer leg substantially form a u-shape adapted to secure the hook to another surface.

12. The pneumatic hose fastener recited in claim 11, wherein the at least one hole is two overlapping non-concentric holes of different sizes.

13. The pneumatic hose fastener recited in claim 12, wherein a waist is constructed between the two overlapping non-concentric holes.

14. The pneumatic hose fastener recited in claim 13, wherein the waist has a pinch point between a larger hole and a smaller hole of the two overlapping non-concentric holes.

15. The pneumatic hose fastener recited in claim 14, wherein the pinch point is smaller than an outer diameter of the smaller hole so that the pneumatic hose snugly placed within the smaller hole does not slip out of position.

16. The pneumatic hose fastener recited in claim 11, wherein an end of the outer leg adjacent to the inner leg forms a bridge that extends from the inner leg.

17. A pneumatic hose fastener comprising:
a flange having two overlapping non-concentric holes;
a neck attached to the flange; and
a hook attached to the neck, the hook comprising:
an inner hook leg;
an outer hook leg; and
a bridge extending between the inner hook leg and the outer hook leg that connects to the neck,
wherein the side profile of the inner hook leg, the bridge and the outer hook leg form substantially a u-shape adapted to secure the hook of the pneumatic hose fastener to another surface.

18. The pneumatic hose fastener recited in claim 17, wherein a waist is constructed between the two overlapping non-concentric holes.

19. The pneumatic hose fastener recited in claim 18, wherein the waist has a pinch point between a larger hole and a smaller hole of the two overlapping non-concentric holes.

20. The pneumatic hose fastener recited in claim 19, wherein the pinch point is smaller than an outer diameter of the smaller hole so that the pneumatic hose snugly placed within the smaller hole does not slip out of position.
